(19) United States
(12) Patent Application Publication
(10) Pub. No.: US 2026/0008880 A1
(43) Pub. Date: Jan. 8, 2026

(54) WATER-SOLUBLE POLYMER COMPRISING HYDROXAMIC ACID GROUPS

(71) Applicant: BASF SE, Ludwigshafen am Rhein (DE)

(72) Inventors: Christian SCHMIDTKE, Lemfoerde (DE); Torben GAEDT, Traunstein (DE); Viktoria KRAUS, Trostberg (DE); Erik GUBBELS, Ludwigshafen am Rhein (DE); Alexander SCHOEBEL, Trostberg (DE); Kai Steffen WELDERT, Trostberg (DE); Johannes NEBAUER, Trostberg (DE); Kerstin BICHLER, Trostberg (DE); Alexander KRONAST, Trostberg (DE); Uwe GEHRIG, Trostberg (DE); Martin WINKLBAUER, Trostberg (DE)

(21) Appl. No.: 19/110,837

(22) PCT Filed: Sep. 7, 2023
(86) PCT No.: PCT/EP2023/074520

§ 371 Date: Mar. 12, 2025

(30) Foreign Application Priority Data
Sep. 16, 2022 (EP) 22196016.4

(51) Int. Cl. C08F 290/06; C04B 28/04; C04B 103/00; C08F 6/02; C08F 6/28; C08F 8/32; C09K 23/46

(52) U.S. Cl. CPC C08F 290/062; C04B 28/04; C08F 6/02; C08F 6/28; C08F 8/32; C09K 23/46; C04B 2103/0053

(57) ABSTRACT

The invention relates to a water-soluble polymer comprising a main chain which consists of a carbon chain with at least 16 carbon atoms and polyether side chains, wherein hydroxamic acid groups or their salts are attached to the main chain. Further disclosed is an inorganic particle composition comprising the water-soluble polymer. A further aspect of the present invention is the use of the water-soluble polymer of the invention as dispersant in inorganic particle compositions.

The invention relates to a water-soluble polymer comprising a main chain which consists of a carbon chain with at least 16 carbon atoms and polyether side chains, wherein hydroxamic acid groups or their salts are attached to the main chain. Further disclosed is an inorganic particle composition comprising the water-soluble polymer. A further aspect of the present invention is the use of the water-soluble polymer of the invention as dispersant in inorganic particle compositions.

Polyacrylates, lignin-sulphonates, melamine-sulphonates, polycarboxylate ethers, and naphthalene-sulphonates are very widely employed as dispersing agents (flow agents) for inorganic particle compositions. One main application area are construction chemical preparations in order to reduce the water requirement of an otherwise identical composition or in order to improve the processability of an otherwise identical composition. Further application areas are inorganic pigment compositions comprising dry ground minerals, usually metals and metal salts, and typically used for imparting colour in a number of applications.

All the dispersing agents mentioned are polyelectrolytes which, due to their charge carrier in the polymer, are adsorbed onto the surfaces of inorganic particles and as a result modify the surface charge of the particles (electrostatic dispersing mechanism). Comb polymers (polycarboxylate ethers) comprise a main chain (“backbone”), along which the functional groups capable of adsorption—as a rule carboxylates—are arranged, and—in contrast to the other dispersing agents mentioned-side chains which are built up, for example, from non-charged hydrophilic ethylene oxide units. These side chains take up a large amount of space (sterically demanding) and therefore additionally influence the dispersing action (steric dispersing mechanism). The polymers are adsorbed via their anionic groups onto the positively charged regions of the particles, while the side chains project into the pore space filled with mixing water and in this way inhibit, by steric hindrance, agglomeration of the solid particles, which explains the dispersing action. Up to the so-called saturation dose, the dispersing action of the dispersing agents (e.g. measurable by slump) increases as the amount added or the amount of polyelectrolyte adsorbed increases.

Conventional examples of superplasticizers for use with gypsum are melamine sulfonate—formaldehyde condensation products (MFS) and beta-naphthalene sulfonate—formaldehyde condensation products (BNS). The preparation and use of BNS is well known in the art and disclosed in EP 0 214 412 B1 and DE 2 007 603 C1. The preparation and use of MFS is also well known in the art. MFS dispersants are disclosed e.g. in DE 44 11 797 A1, DE 195 38 821 A1 and EP 0 059 353 B1.

The use of copolymers based on polycarboxylate ethers as plasticizers and consistency maintainers for binders based on calcium sulfate is likewise adequately known. Such copolymers consist essentially of an olefinically unsaturated monocarboxylic acid comonomer or an ester or a salt thereof and/or an olefinically unsaturated sulfonic acid comonomer together with a comonomer having a polyether function.

However, the typical natural gypsum sources that are commercially available often contain clay mineral and other impurities of up to 20% or more that result in reduced calcium sulfate levels.

Clay is the common name for a number of fine-grained, earthy materials that become plastic when wet and are mostly composed of phyllosilicate minerals containing variable amounts of water trapped in the mineral structure. There are many types of known clay minerals. Some of the more common types are: kaolinite, illite, chlorite, vermiculite, and smectite, also known as montmorillonite, the latter two have pronounced ability to adsorb water.

Chemically, clays are hydrous aluminum silicates, usually containing alkaline metals, alkaline earth metals and/or iron. The clay mineral consists of sheets of interconnected silicates combined with a second sheet-like grouping of metallic atoms, oxygen, and hydroxyl, forming a two-layer mineral as in kaolinite. Sometimes the latter sheet like structure is found sandwiched between two silica sheets, forming a three-layer mineral such as in vermiculite. Structurally, the clay minerals are composed of planes of cations, arranged in sheets, which may be tetrahedral or octahedral coordinated (with oxygen), which in turn are arranged into layers often described as 2:1 if they involve units composed of two tetrahedral and one octahedral sheet or 1:1 if they involve units of alternating tetrahedral and octahedral sheets. Additionally, some 2:1 clay minerals have interlayer sites between successive 2:1 units which may be occupied by interlayer cations that are often hydrated. Clay minerals are divided by layer type, and within layer type, by groups based on charge x per formula unit (Guggenheim S. et al., Clays and Clay Minerals, 54 (6), 761-772, 2006). The charge per formula unit, x, is the net negative charge per layer, expressed as a positive number. Further subdivisions by sub-groups are based on dioctahedral or trioctahedral character, and finally by species based on chemical composition e.g.
x=0: pyrophyllite-group
x=0.2-0.6: smectite-group e.g. montmorillonite, nontronite, saponite or hectorite
x=0.6-0.9: vermiculite-group
x=1.8-2: brittle mica-group e.g. clintonite, anandite, kinoshitalite.

Conventional dispersants for gypsum compositions typically achieve good water reduction when pure gypsum sources are used e.g. flue gas desulphurization gypsum (FGD gypsum), however in natural gypsum sources which contain clay mineral and other impurities, conventional dispersants have a low dosage efficiency and the amount of dispersant needs to be adjusted for the specific application. Additional amounts of dispersants however retard the crystallization of calcium sulfate dihydrate and therefore lead to adverse effects in many applications, for example in the production of gypsum wallboards.

It is further a common practice to employ dispersants to help stabilise the aqueous suspensions of pigments. Inorganic pigments often consist of dry ground minerals, usually metals and metal salts, and typically used for imparting colour in a number of applications. Typical applications include the manufacture of many products such as paper, card or other paper products, plastics, paint or other coatings. Aqueous dispersions of pigments are generally used to contribute to the mechanical and optical properties of the products into which they are applied.

A wide variety of dispersants are known for dispersing and/or stabilising aqueous suspensions of pigments so as to reduce or prevent the settling of pigment particles in suspension. Such dispersants include, for instance, silicates or phosphates, phosphonates or oligomeric species carrying functional groups.

In general, there is an increasing requirement to provide aqueous inorganic pigment slurries which are both high solids and low viscosity.

It was therefore an object of the present invention to provide dispersants having a high dosage efficiency for inorganic particle compositions, especially in inorganic binder or inorganic pigment compositions. A subtarget of the invention was to provide dispersants for binder compositions, wherein the dispersant provides high dosage efficiency in calcium sulfate binders with and without clay mineral impurities. At the same time it was a further object to provide dispersants which also reduce the retardation in inorganic binder systems compared to polycarboxylate ethers. It was a further objective of the present invention to provide a dispersant which enables high solid aqueous slurries of inorganic pigments which exhibit acceptable or lower viscosities. It was also an important objective to achieve acceptable or improved solids content with acceptable or improved viscosity with increased stability of the slurry.

The object of the invention is solved by a water-soluble polymer comprising
a) a main chain which consists of a carbon chain with at least 16 carbon atoms and
b) polyether side chains, characterized in that hydroxamic acid groups or their salts are attached to the main chain.

In one preferred embodiment the polyether groups of the at least one water-soluble polymer are polyether groups of the structural unit (I),

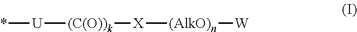

where
* indicates the bonding site to the acid group-containing polymer,
U is a chemical bond or an alkylene group having 1 to 8 C atoms,
X is oxygen, sulfur or a group NR1,
k is 0 or 1,
n is an integer whose average value, based on the acid group-containing polymer, is in the range from 3 to 300,
Alk is C₂-C₄ alkylene, and within group (Alk-O)ₙ Alk may be identical or different,
W is a hydrogen, a C₁-C₆ alkyl, or an aryl radical or is the group Y-F, where
Y is a linear or branched alkylene group having 2 to 8 C atoms and may carry a phenyl ring,
F is a 5- to 10-membered nitrogen heterocycle which is bonded via nitrogen and which as ring members, besides the nitrogen atom and beside carbon atoms, may have 1, 2 or 3 additional heteroatoms selected from oxygen, nitrogen, and sulfur, it being possible for the nitrogen ring members to have a group R², and for 1 or 2 carbon ring members to be present in the form of a carbonyl group,
R¹ is hydrogen, C₁-C₄ alkyl or benzyl, and
R² is hydrogen, C₁-C₄ alkyl or benzyl.

In one preferred embodiment the water-soluble polymer is a copolymer comprising structural units (Va)

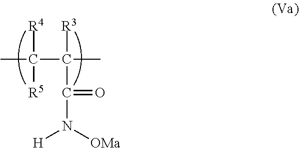

wherein
R³ and R⁴ independently from each other are hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms,
R⁵ is H, —COOMₐ, —CO—NH—(OMₐ), —CO—O(C_{q}H_{2q}O)ᵣ—R³, —CO—NH—(C_{q}H_{2q}O)ᵣ—R³
M is hydrogen, a mono-, di- or trivalent metal cation, ammonium ion, or an organic amine radical
a is ⅓, ½ or 1
q independently at each occurrence and in a manner identical or different for each (C_{q}H_{2q}O) unit is 2, 3 or 4 and
r is 0 to 200.

In particular M is hydrogen, a mono-, di- or trivalent metal cation, preferably sodium, potassium, calcium or magnesium ion, additionally ammonium or an organic amine radical, and a=⅓, ½ or 1, according to whether M is a mono-, di- or trivalent cation.

Organic amine radicals used are preferably substituted ammonium groups which derive from primary, secondary or tertiary C₁₋₂₀ alkylamines, C₁₋₂₀ alkanolamines, C₅₋₈ cycloal-kylamines, and C₆₋₁₄ arylamines. Examples of the amines in question are methylamine, dimethylamine, trimethylamine, ethanolamine, diethanolamine, triethanolamine, methyl-diethanolamine, cyclohexylamine, dicyclohexylamine, phenylamine, diphenylamine in the protonated (ammonium) form.

In one particularly preferred embodiment the substituents in structural unit (Va) have the following meaning
R³ and R⁴ independently from each other are hydrogen, an aliphatic hydrocarbon radical having 1 to 10 C atoms,
R⁵ is H, —COOMₐ,
M is hydrogen, a mono-, di-or trivalent metal cation, ammonium ion, or an organic amine radical a is ⅓, ½ or 1.

In a further preferred embodiment the water-soluble polymer is a copolymer comprising structural units (Vb)

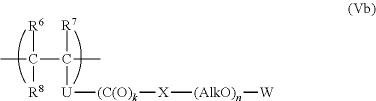

R⁶, R⁷ and R⁸ independently from each other are hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms, and
U, k, X, Alk, n and W possess definitions stated above.

In one particularly preferred embodiment the substituents in structural unit (Vb) have the following meaning
R⁶, R⁷ and R⁸ independently from each other are hydrogen, an aliphatic hydrocarbon radical having 1 to 10 C atoms,
U is a chemical bond or an alkylene group having 1 to 8 C atoms,
X is oxygen,
k is 0 or 1,
n is an integer whose average value, based on the acid group-containing polymer, is in the range from 10 to 200,
Alk is C₂-C₄ alkylene, and within group (Alk-O)ₙ Alk may be identical or different,
W is a hydrogen or a C₁-C₆ alkyl.

In one particular embodiment, furthermore, the present invention provides for a sodium, potassium, ammonium and/or calcium salt, and preferably a sodium and/or potassium salt, of the copolymer.

In a preferred embodiment of the invention, the copolymers of the invention comprise at least one further structural unit which is different from the structural units of the general formula (Va) and (Vb) (further monomer). Of course, the copolymer can also comprise a plurality of structural units which are different from the structural units of the general formula (Va) and (Vb).

The copolymers may therefore be based on at least one further monomer, particularly preferably a monoethylenically unsaturated monomer.

Suitable further monomers are C₂-C₂₄-alkenes, for example ethene, propene, 1-butene, 2-butene, isobutene, diisobutene, 1-hexene, 1-heptene, 1-octene, 1-nonene, 1-decene, 1-dodecene, 1-octadecene.

Other suitable further monomers are also conjugated C₄-C₁₀-dienes, for example butadiene, isoprene or chloroprene.

The further monomer, in particular mono ethylenically unsaturated further monomer, can be, in particular, a monomer comprising at least one acid group, where the acid group can also be fully or partially neutralized. Here, the monomers can be, for in particular, alkali metal salts, alkaline earth metal salts, ammonium salts or salts of organic ammonium ions. The monomer can preferably be a monomer comprising at least one acid group selected from the group consisting of carboxylic acid, sulfonic acid, phosphoric acid or phosphonic acid groups.

Examples of a suitable further monomer having carboxylic acid groups encompass C₃-C₁₂ monoethylenically unsaturated monocarboxylic or dicarboxylic acids and anhydrides or salts thereof, for example acrylic acid, methacrylic acid, (meth) acrylic anhydride, crotonic acid, maleic acid, maleic anhydride, fumaric acid, itaconic acid, mesaconic acid, citraconic acid or methylenemalonic acid and ammonium or alkali metal salts thereof. The acids can be used in entirely or partly neutralized form.

Examples of a suitable further monomer having a phosphoric acid or phosphonic acid group encompass monoethylenically unsaturated phosphonic esters or (poly)phosphoric esters and salts thereof, for example vinylphosphonic acid or esters of hydroxyethyl, hydroxypropyl or hydroxybutyl (meth)acrylate with (poly)phosphoric acid and alkali metal and ammonium salts thereof, monovinyl phosphate, allylphosphonic acid, monoallyl phosphate, 3-butenylphosphonic acid, mono-3-butenyl phosphate, mono(4-vinyloxybutyl) phosphate, mono(2-hydroxy-3-vinyloxypropyl) phosphate, mono(1-phosphonoxymethyl-2-vinyloxyethyl) phosphate, mono(3-allyloxy-2-hydroxypropyl) phosphate, mono-2-(allyloxy-1-phosphonoxymethylethyl) phosphate, 2-hydroxy-4-vinyloxymethyl-1, 3,2-dioxaphosphole, 2-hydroxy-4-allyloxymethyl-1,3,2-dioxaphosphole. It is also possible to use salts and/or esters, in particular C₁-C₈-monoalkyl, dialkyl and optionally trialkyl esters of phosphoric acid and/or monomers comprising phosphonic acid groups.

Examples of a suitable further monomer having sulfonic acid groups encompass monoethylenically unsaturated sulfonic acids and salts thereof, for example vinylsulfonic acid, 2-acrylamido-2-methylpropanesulfonic acid, 2-acrylamidomethyldodecylsulfonic acid, 2-(meth)acryloxyethanesulfonic acid, 3-(meth)acryloxypropanesulfonic acid, allyloxybenzenesulfonic acid, vinylbenzenesulfonic acid, vinyltoluenesulfonic acid, allylsulfonic acid, methallylsulfonic acid and their corresponding ammonium and alkali metal salts.

Suitable further monomers are also esters, amides and imides of monoethylenically unsaturated monocarboxylic or dicarboxylic acids, in particular of the abovementioned monoethylenically unsaturated C₃-C₁₂-carboxylic acids, in particular C₁-C₄₀, preferably C₁-C₂₂, particularly preferably C₂-C₁₂ esters, amides or imides. The substituents can here also bear further heteroatoms. Dicarboxylic acids can also be present in the form of their monoesters or monoamides, for example as C₁-C₄ monoesters. The amides and imides can be present in N-monoalkylated or optionally N, N-dialkylated form.

Esters can be, in particular, esters of (meth)acrylic acid, in particular (meth)acrylic esters having aliphatic or cycloaliphatic ester groups, in particular C₁-C₂₂, preferably C₂-C₁₂ ester groups. Examples of such compounds encompass methyl (meth)acrylate, ethyl (meth)acrylate, propyl (meth)acrylate, isopropyl (meth)acrylate, 1-butyl (meth)acrylate, isobutyl (meth)acrylate, tert-butyl (meth)acrylate, pentyl (meth)acrylate, isoamyl (meth)acrylate, hexyl (meth)acrylate, heptyl (meth)acrylates, isodecyl (meth)acrylate, lauryl (meth)acrylate, stearyl (meth)acrylate, behenyl (meth)acrylate, cyclohexyl (meth)acrylate, 4-tert-butylcyclohexyl (meth)acrylate, isobornyl (meth)acrylate, 2-ethylhexyl (meth)acrylate, 2-propylheptyl (meth)acrylate or citronellol (meth)acrylate.

The ester groups can also comprise heteroatoms, in particular O and/or N atoms. Examples of such esters encompass hydroxyethyl (meth)acrylate, hydroxypropyl (meth)acrylate, hydroxybutyl (meth)acrylate, ethyl diglycol (meth)acrylate, hydroxypropyl carbamate (meth)acrylate, phenyl (meth)acrylate, benzyl (meth)acrylate, 2-phenylethyl (meth)acrylate, 3-phenylpropyl (meth)acrylate, ureido (meth)acrylate, acetoacetoxyethyl (meth)acrylate, hydroxyethylpyrrolidone (meth)acrylate, tert-butylaminoethyl (meth)acrylate, diethylaminoethyl (meth)acrylate, dimethylaminoethyl (meth)acrylate. Examples of preferred esters of (meth)acrylic acid encompass hydroxyethyl (meth)acrylate, hydroxypropyl (meth)acrylate and hydroxybutyl (meth)acrylate.

The alcohol components in the (meth)acrylic esters can also be alkoxylated alcohols. Here, mention may be made of, in particular, alkoxylated C₁-C₁₈-alcohols which comprise from 2 to 80 mol of ethylene oxide, propylene oxide, butylene oxide or mixtures thereof. Examples of such alkoxylated products encompass methylpolyglycol (meth)acrylate or (meth)acrylic esters of C₁₃/C₁₅ OXO alcohol reactive with 3, 5, 7, 10 or 30 mol of ethylene oxide, or mixtures thereof.

Further examples of esters, amides or imides encompass monoethyl maleate, diethyl maleate, dimethyl maleate, N-substituted maleimides such as N-methylmaleimide, N-phenylmaleimide and N-cyclohexylmaleimide, acrylamide, methacrylamide, N-methyl(meth)acrylamide, N,N-dimethyl(meth)acrylamide, N,N-diethylacrylamide, N-isopropyl (meth)acrylamide, N-methylol(meth)acrylamide, N-hydroxyethyl(meth)acrylamide, N-tert-butyl(meth)acrylamide, N-tert-octyl(meth)acrylamide, N-(1-methylundecyl) (meth)acrylamide, 10-acrylamidoundecanoic acid, N-cyclohexyl(meth)acrylamide, diacetoneacrylamide, dimethylaminoethyl(meth)acrylamide, dimethylaminopropyl (meth)acrylamide, N,N-dimethyl-N-(meth)acrylamidopropyl-N-(3-sulfopropyl)ammonium betaine, (meth)acryloylmorpholine.

Monomers bearing amino or imino groups can also be present in protonated form or in the form of their quaternized salts, for example by quaternization with methyl chloride, dimethyl sulfate or diethyl sulfate. The monomers can also have been reacted with propane sultone to form the corresponding betaines.

Further monomers which are likewise suitable are monomers comprising N-vinyl groups, for example N-vinylpyrrolidone, N-vinylcaprolactam, N-vinyl-N-methylacetamide, N-vinylimidazole, 2-methyl-1-vinylimidazole, quaternized N-vinylimidazole derivatives, for example 1-vinyl-3-methylimidazolium chloride or methosulfate, N-vinyl-1,2,4-triazole, N-vinylcarbazole, N-vinylformamide, 2-methyl-1-vinylimidazoline.

Suitable further monomers are C₁-C₂₄ esters of vinyl alcohol and monocarboxylic acids, for example vinyl formate, vinyl acetate, vinyl propionate, vinyl-n-butyrate, vinyl laurate, vinyl stearate, or vinyl esters of Koch acids, for example of 2,2-dimethylpropanoic acid, 2,2-dimethylbutanoic acid, 2,2-dimethylpentanoic acid, 2-ethyl-2-methylbutanoic acid, neononanoic acid, neodecanoic acid.

Vinyl or allyl ethers such as methyl vinyl ether, ethyl vinyl ether, propyl vinyl ether, iso-butyl vinyl ether, tert-butyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, hydroxybutyl vinyl ether, 2-(diethylamino)ethyl vinyl ether, 2-(di-n-butylamino)ethyl vinyl ether or methyl diglycol vinyl ether and the corresponding allyl compounds are also suitable.

Further suitable monomers are unsaturated alcohols such as 3-buten-1-ol, 2-buten-1-ol, allyl alcohol, isoprenol, prenol, methallyl alcohol.

Suitable further monomers are likewise N-allyl compounds, for example diallylamine, N,N-dimethyl-N,N-diallylammonium chloride.

Suitable further monomers are also α,β-monoethylenically unsaturated nitriles having from 3 to 10 carbon atoms, for example acrylonitrile, methacrylonitrile, fumaronitrile, maleonitrile.

Suitable further monomers are additionally vinylaromatic monomers such as styrene, vinyltoluene or α-methylstyrene. Further styrene derivatives conform to the general formula VI

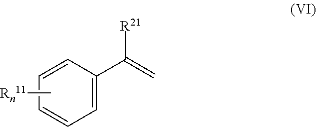

where R¹¹ and R²¹ are each hydrogen or C₁-C₈-alkyl and n is 0, 1, 2 or 3. The aromatic ring can additionally bear heteroatoms, for example 2- and 4-vinylpyridine.

Suitable further monomers are additionally halogenated alkenes, for example vinyl chloride, vinylidene chloride, trifluoroethylene, tetrafluoroethylene, and also acrolein, methacrolein.

The further monomers can also be monomers having a crosslinking effect. Examples of suitable crosslinking further monomers encompass molecules having a plurality of ethylenically unsaturated groups, for example di(meth)acrylates such as ethylene glycol di(meth)acrylate, 1,4-butanediol di(meth)acrylate or hexanediol di(meth)acrylate, or poly(meth)acrylates such as trimethylolpropane tri(meth)acrylate, pentaerythritol tri(meth)acrylate or else di (meth)acrylates of oligoalkylene or polyalkylene glycols, e.g. diethylene, triethylene or tetraethylene or dipropylene, tripropylene or tetrapropylene glycol di(meth)acrylate. Further examples encompass divinylbenzene, divinylethyleneurea, vinyl (meth)acrylate, allyl (meth)acrylate, isoprenyl (meth)acrylate, prenyl (meth)acrylate, dihydrodicyclopentadienyl acrylate, dicyclopentadienyl (meth)acrylate or butanediol divinyl ether. Diallyl and oligoallyl or vinyl ethers of polyhydroxy compounds, for example ethylene glycol divinyl ether, butanediol divinyl ether, 1,4-cyclohexanedimethanol divinyl ether, diethylene glycol divinyl ether, triethylene glycol divinyl ether, pentaerythritol triallyl or tetraallyl ether, are likewise suitable. Oligoallylamines, for example triallylamine or tetraallylammonium chloride are likewise suitable. Diallyl and oligoallyl esters of polycarboxylic acid, for example diallyl phthalate, diallyl maleate, triallyl trimellitate, divinyl esters of dicarboxylic acids such as succinic acid and adipic acid are likewise suitable. Di(meth)acrylamides, tri(meth)acrylamides or oligo (meth)acrylamides, for example N,N′-methylenebis (meth)acrylamide, are likewise suitable. The content of crosslinking monomers is generally from 0 to 20 mol %, based on the total number of all monomers, preferably from 0.1 to 10 mol % and particularly preferably from 0.2 to 5 mol %. The polymers according to the invention preferably do not comprise any crosslinking monomers.

Examples of preferred monoethylenically unsaturated further monomers encompass styrene, butadiene, methyl (meth)acrylate, ethyl acrylate, dibutyl maleate, methyl-alpha-cyanoacrylate, acrylonitrile, acrylic acid, methacrylic acid, maleic acid/anhydride, itaconic acid, vinylphosphonic acid, N-vinylpyrrolidone, N,N-dimethyl-N,N-diallylammonium chloride, acrylamide, vinylimidazole, vinyl acetate, allylsulfonic acid, 2-acrylamido-2-methylpropanesulfonic acid, particularly preferably acrylic acid, meth-acrylic acid, methyl (meth)acrylate, maleic acid/anhydride, (iso)prenyl alkoxylate, (meth)allyl alkoxylate or hydroxybutyl vinyl ether alkoxylate. Very particular preference is given to acrylic acid, methacrylic acid, (meth)acrylate, maleic acid/anhydride, (iso) prenyl alkoxylate, (meth)allyl alkoxylate or hydroxybutyl vinyl ether alkoxylate.

In a further preferred embodiment of the copolymers according to the invention, acrylic acid is comprised in the polymer as at least one further structural unit which is different from the structural units of the general formula (Va) and (Vb). In this case, particular preference is given to no further structural units apart from structural units of the general formula (Va) and (Vb) and structural units based on acrylic acid being comprised.

In a further preferred embodiment of the copolymers according to the invention, methacrylic acid is comprised in the polymer as at least one further structural unit which is different from the structural units of the general formula (Va) and (Vb). In this case, particular preference is given to no further structural units apart from the general formula (Va) and (Vb) and structural units based on methacrylic acid being comprised.

In a further preferred embodiment of the copolymers according to the invention, maleic acid/anhydride is comprised in the polymer as at least one further structural unit which is different from the structural units of the general formula (Va) and (Vb). In this case, particular preference is given to no further structural units apart from the general formula (Va) and (Vb) and structural units based on maleic acid/anhydride being comprised.

The copolymers according to the invention can further comprise small amounts of initiators or chain transfer agents because of the way in which they are prepared.

In further preferred embodiments of the copolymers according to the invention, beside (Va), (Vb) and structural units based on acrylic acid and methacrylic acid or acrylic acid and maleic acid/anhydride or methacrylic acid and maleic acid/anhydride, no further structural units are comprised.

In further preferred embodiments of the copolymers according to the invention, beside (Va), (Vb) and structural units based on acrylic acid, methacrylic acid and maleic acid/anhydride, no further structural units are comprised.

In a preferred embodiment, the copolymers according to the invention comprise from 5 to 99% by weight of unsaturated compounds of the general formula (Va) and from 5 to 99% by weight of unsaturated compounds of the general formula (Vb), in each case based on the total amount of monomers in the polymer. Preferably the copolymers according to the invention comprise from 10 to 90% by weight of unsaturated compounds of the general formula (Va) and from 10 to 90% by weight of unsaturated compounds of the general formula (Vb), in each case based on the total amount of monomers in the polymer.

The average molecular weight M_{w} of the copolymer of the invention as determined by gel permeation chromatography (GPC) is preferably 2 000 to 200 000 g/mol, more preferably 5 000 to 80 000 g/mol, and very preferably 8 000 to 70 000 g/mol. The polymers were analyzed for average molar mass and conversion by means of size extrusion chromatography (column combinations: OH-Pak SB-G, OH-Pak SB 804 HQ, and OH-Pak SB 802.5 HQ from Shodex, Japan; eluent: 80 vol % aqueous solution of HCO₂NH₄ (0.05 mol/l) and 20 vol % acetonitrile; injection volume 100 μl; flow rate 0.5 ml/min). The calibration to determine the average molar mass took place with linear polyethylene glycol standards. As a measure of the conversion, the peak of the copolymer is standardized to a relative height of 1, and the height of the peak of the unreacted macromonomer/PEG-containing oligomer is used as a measure of the residual monomer content.

In one particularly preferred embodiment, the water-soluble polymer is a polycondensation product comprising
(II) a structural unit containing an aromatic or heteroaromatic and the polyether group,
(III) a structural unit containing a hydroxamic acid group or their salts and an aromatic or heteroaromatic moiety.

The structural units (II) and (III) are represented preferably by the following general formulae

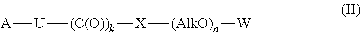

where
A is identical or different and is represented by a substituted or unsubstituted, aromatic or heteroaromatic compound having 5 to 10 C atoms in the aromatic sytem,
U, k, X, Alk, n and W possess definitions stated in structural unit (I),

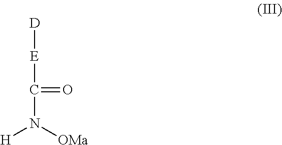

where
D is identical or different and is represented by a substituted or unsubstituted, aromatic or heteroaromatic compound having 5 to 10 C atoms in the aromatic system,
where
E is a chemical bond
or —(C(O))ₖ—X—(AlkO)ₙ—Z—,
wherein
X is oxygen or a group NR⁹, preferably X is oxygen,
k is 0 or 1, preferably k is 0
n is an integer whose average value, based on the acid group-containing polymer, is in the range from 0 to 100, preferably 0 to 25, most preferably 0 to 5,
Alk is C₂-C₄ alkylene, and within group (Alk-O)ₙ Alk may be identical or different,
R⁹ is hydrogen, C₁-C₄ alkyl or benzyl
Z is C₁-C₃ alkylene, preferably Z is C₁ or C₂ alkylene.

The polycondensation product preferably comprises a further structural unit (IV) which is represented by the following formula

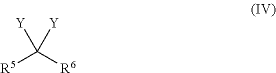

wherein
each Y is independently the structural unit (II), the structural unit (III) or a further constituent of the polycondensation product, and each R⁵ and each R⁶ is independently H, CH₃, COOH, or a substituted or unsubstituted, aromatic or heteroaromatic compound having 5 to 10 carbon atoms.

In one particularly preferred embodiment, R⁵ and R⁶ are represented by H.

The molar ratio of the structural units (II), (III), and (IV) in the polycondensation product of the invention may be varied within wide ranges. It has proven useful for the molar ratio of the structural units [(II) 30 (III)]: (IV) to be 1:0.8 to 3, preferably 1:0.9 to 2, and more preferably 1:0.95 to 1.2.

The molar ratio of the structural units (II):(III) is normally 1:15 to 15:1, preferably 1:7 to 5:1, and more preferably 1:5 to 3:1.

The groups A and D in the structural units (II) and (III) of the polycondensation products are generally represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, and A and D may be selected independently of one another and may also each consist of a mixture of the stated compounds. The group X is represented preferably by O. The group E is represented preferably by a chemical bond.

In structural unit (II), n is preferably represented by an integer from 5 to 280, more particularly 10 to 160, and more preferably 12 to 120. The radical whose length is defined by n, may consist here of unitary structural groups, although it may also be useful for there to be a mixture of different structural groups. Furthermore, the radicals of the structural unit (II) may each possess the same chain length, with n and being represented by one number. In general, however, it will be useful for there to be in each case mixtures with different chain lengths, so that the radicals of the structural units in the polycondensation product have different numerical values for n.

In one particular embodiment, furthermore, the present invention provides for a sodium, potassium, ammonium and/or calcium salt, and preferably a sodium and/or potassium salt, of the polycondensation product.

The polycondensation product of the invention frequently has a weight-average molecular weight as determined by gel permeation chromatography (GPC) of 3000 g/mol to 150 000 g/mol, preferably 5000 to 100 000 g/mol, and more preferably 10 000 to 75 000 g/mol. The polymers were analyzed for average molar mass and conversion by means of size extrusion chromatography (column combinations: OH-Pak SB-G, OH-Pak SB 804 HQ, and OH-Pak SB 802.5 HQ from Shodex, Japan; eluent: 80 vol % aqueous solution of HCO₂NH₄ (0.05 mol/l) and 20 vol % acetonitrile; injection volume 100 μl; flow rate 0.5 ml/min). The calibration to determine the average molar mass took place with linear polyethylene glycol standards. As a measure of the conversion, the peak of the copolymer is standardized to a relative height of 1, and the height of the peak of the unreacted macromonomer/PEG-containing oligomer is used as a measure of the residual monomer content.

In a preferred embodiment the polymer of the invention comprises at least one from the series of carboxyl, phosphono, sulfino, sulfo, sulfamido, sulfoxy, sulfoalkyloxy, sulfinoalkyloxy, and phosphonooxy group. Particularly preferred are carboxyl and phosphonooxy groups.

In a preferred embodiment of the invention the polymer has an average ratio of the number of moles of hydroxamic acid groups or their salts to the total molar mass of the polymer of from 1/200 to 1/2000 mol/(g/mol), wherein cations, including protons, associated with the comb polymer are not taken into account in calculating the total molar mass of the polymer.

In one particularly preferred embodiment, the composition of the invention is in powder form. The average particle size of the powders of the invention is preferably less than 400 μm, more preferably less than 100 μm, and more particularly between 1 and 250 μm, more preferably between 1 and 75 μm, as measured by laser granulometry. The term “average particle size” in the sense of the present patent application corresponds to the median of the particle volume distribution, i.e., to the D50 figure.

The present invention further provides a process for the preparation of the water-soluble polymer according to the present invention comprising hydroxamic acid groups or their salts, wherein a water-soluble polymer comprising
a) a main chain which consists of a carbon chain with at least 16 carbon atoms and
b) polyether side chains and
c) carboxylic esters attached to the main chain, is reacted with a hydroxyl amine in an aqueous medium.

In a preferred embodiment, the process is carried out at a pH between 11,5 and 13,5.

In a further preferred embodiment, the process is carried out at temperature between 10 and 50. Preferably the source of hydroxyl amine is hydroxyl amine hydrochloride or hydroxylammonium sulfate,

In one particular embodiment, furthermore, the present invention provides inorganic particle compositions comprising a water-soluble polymer according to the invention. In one particularly preferred embodiment, the composition comprises inorganic binders or inorganic pigments.

The inorganic binder is preferably at least one from the group consisting of cement based on Portland cement, white cement, calcium aluminate cement, calcium sulfoaluminate cement, calcium sulfate n-hydrate, and latent hydraulic and/or puzzolanic binder.

The binder based on calcium sulfate may be present in different hydrate states. Preferred binders of the invention are α-calcium sulfate hemihydrate, ß-calcium sulfate hemihydrate, and the anhydrite, which is free from water of crystallization, or mixtures of the stated binders. Particularly preferred is ß-calcium sulfate hemihydrate, and especially preferred is ß-calcium sulfate hemihydrate containing anhydrite, more particularly anhydrite III. It is also possible for anhydrite dust (finely ground anhydrite) to be employed, this being relatively slow to react and producing only partial setting.

In a preferred embodiment of the present invention the binder based on calcium sulfate comprises clay. The clay content typically is in the range from 0.0001 weight-% to 15 weight-%, preferably from 0.01 weight-% to 10 weight-% based on the weight of gypsum. A further aspect of the invention is a gypsum containing composition as described above wherein the clay is a swellable clay, including but not limited to clays such as bentonite.

In one particular embodiment, the composition comprising inorganic binders contains preferably at least 30 wt %, especially preferably at least 50 wt %, most preferably at least 70 wt % of calcium sulfate based binder, more particularly calcium sulfate β-hemihydrate, based on the total weight of the mineral binder. The composition comprising inorganic binders may include other mineral binders, examples being hydraulically setting substances, such as cement, more particularly Portland cements or fused-alumina cements, and their mixtures, respectively, with flyash, silica dust, slags, slag sands and limestone or burnt lime. The mixture may further comprise other additions, such as fibres, for example, and also constituents customary as additives, such as other dispersants, for example, examples being lignosulphonates, sulphonated naphthalene-formaldehyde condensates, sulphonated melamine-formaldehyde condensates or polycarboxylate ethers (PCE), accelerators, retardants, starch, sugars, silicones, shrinkage reducers, defoamers or foam formers.

In a further-preferred embodiment, the composition comprising inorganic binders is a dry-mix mortar. As a result of continual effort toward extensive rationalization and also improved product quality, mortars for a very wide variety of different uses within the construction sector are nowadays hardly any longer mixed together from the starting materials on the building site itself. This function is nowadays largely carried out by the construction materials industry in the factory, and the ready-to-use mixtures are provided in the form of what are called factory dry-mix mortars. Finished mixtures which can be made workable on site exclusively by addition of water and mixing are referred to, according to DIN 18557, as factory mortars, more particularly as factory dry-mix mortars. Mortar systems of this kind may fulfill any of a very wide variety of physical construction objectives. Depending on the objective that exists, the binder-which may comprise, for example, cement and/or lime and/or calcium sulfate-is admixed with further additives and/or admixtures in order to adapt the factory dry-mix mortar to the specific application. The additives and admixtures in question may comprise, for example, shrinkage reducers, expansion agents, accelerators, retardants, dispersants, thickeners, defoamers, air entrainers, and corrosion inhibitors.

The factory dry-mix mortar of the invention may in particular comprise masonry mortars, render mortars, mortars for thermal insulation composite systems, renovating renders, jointing mortars, tile adhesives, thin-bed mortars, screed mortars, casting mortars, injection mortars, filling compounds, grouts, or lining mortars (for drinking-water pipes, for example).

Also included are factory mortars which on production on the building site may be provided not only with water but also with further components, especially liquid and/or pulverulent additives, and/or with aggregate (two-component systems).

The composition comprising inorganic binders of the invention, may in particular also comprise a binder mixture as its binder. Understood as such in the present context are mixtures of at least two binders from the group consisting of cement, puzzolanic and/or latent hydraulic binder, white cement, specialty cement, calcium aluminate cement, calcium sulfoaluminate cement, and the various hydrous and anhydrous calcium sulfates. These mixtures may then optionally comprise further additives.

In a further-preferred embodiment, the inorganic particle composition of the invention comprises inorganic pigments. Preferably the inorganic pigment is selected from the group of titanium dioxide, kaolin, china clay, talc, calcium hydroxide, ultrafine precipitated calcium carbonate, ground calcium carbonate, black pigments such as iron (III) oxide or titanium (III) oxide or manganese oxide. In a preferred embodiment the pigments are present in the form of a pigment slurry.

The invention is particularly suitable for these inorganic pigment slurries which tend to have especially fine particle sizes, especially as these inorganic pigment slurries suitably have a pH of greater the 7. The invention addresses the problem that when producing these specific inorganic pigment slurries it can be difficult to obtain the balance of properties. The invention can be suitable for forming stable and effective aqueous slurries of such inorganic pigments.

In one particular embodiment, the inorganic pigment slurries comprise the water-soluble polymer according to the invention in doses of up to 3% by weight, based on the total dry weight of the pigment particles. Generally, though, the optimum dose of the polymer is often below this level. The exact dose may vary according to the particular inorganic pigment, the average particle size of the pigment and the required solids content of the slurry thereof.

In a preferred embodiment, the inorganic particle compositions according to the invention comprise 0.005 to 3 weight-%, preferably 0.03 to 2 weight-% most preferably 0.07 to 1 weight-% of the water-soluble polymer based on the total dry weight of the inorganic particles.

Finally, the present invention also includes the use of a water-soluble polymer according to the invention as dispersant in inorganic particle compositions. Preferably the water-soluble polymer according to the invention is used for controlling the flowability of aqueous chemical construction suspensions, preferably based on inorganic binders and in particular comprising at least one of the following inorganic binders: calcium sulfate n-hydrate, hydraulic binders, latent hydraulic binders.

In a further aspect, water-soluble polymer according to the invention is used for The stabilisation of aqueous slurries of inorganic pigments.

In one particular embodiment, the present invention relates to the use of water-soluble polymer according to the invention for producing shaped gypsum bodies. The term “shaped body” refers to any cured article which has a three-dimensional extent. The curing of the shaped body is accomplished by drying in an oven or in the air. The shaped body of the invention may be a movable object, such as a gypsum board or a sculpture, for example. Alternatively the shaped body of the invention may be a filling or coating, for example a gypsum render, a floor covering or screed, or any product which is formed on the spreading and curing of the filling compound, for example the filling of a cavity or of a joint.

Envisaged with particular preference for the present invention are shaped gypsum bodies in the form of a gypsum plasterboard comprising the dispersant of the invention. Further embraced is a process for producing gypsum plasterboard using a dispersant of the invention. Of critical importance in the production of gypsum construction board, more particularly gypsum plasterboard, is the speed of the setting process. At present worldwide on an annual basis there are more than 8000 million m² of gypsum plaster-board produced. The production of gypsum plasterboard is long-established. It is described, for example, in U.S. Pat. No. 4,009,062. The settable gypsum slurry used, composed of calcium sulfate hemihydrate and water, is typically produced in a flow mixer revolving at high speed, applied continuously to a cardboard web and covered with a second piece of cardboard. The two cardboard webs are referred to as the front and backboards. The line of boards then moves along what is called a setting belt, and at the end of the setting belt almost complete conversion of the settable calcium sulfate phases to form calcium sulfate dihydrate must have taken place. After this hardening, the web is singularized into boards, and the water still present in the boards is removed in heated multi-stage dryers.

Gypsum plasterboard of this kind is used to a large extent in interior outfitting for ceilings and walls.

In order to meet the rising demand and also to minimize production costs, efforts are continually being made to improve the production process. Modern plants for the fabrication of gypsum construction boards can reach manufacturing speeds of up to 180 metres per minute. The greatest possible utilization of the plant capacity is possible only with the use of highly efficient accelerators. The setting time of the calcium sulfate hemihydrate here determines the time until the gypsum plasterboard can be cut, and hence the length and the speed of the conveyor belt, and thus the production rate. Furthermore, hydration must be complete before the boards are exposed to high temperatures in the dryer. Otherwise, the strength potential of the binder is not sufficiently utilized, and the risk arises of volume expansion as a result of post-hydration on ingress of moisture.

There is therefore a considerable economic interest in minimizing the retardation in the setting process through the use of dispersant. The present invention accordingly also embraces a process for producing a gypsum plasterboard that uses the water-soluble polymer according to the invention. The use of the water-soluble polymer of the invention may take place here in the same way as with the dispersants known to date, and so no further changes to the production operation are necessary.

In a further-preferred embodiment, the shaped gypsum body of the invention may be a calcium sulfate-containing self-levelling screed. Further embraced is a process for producing calcium sulfate-containing self-levelling screed that uses a dispersant of the invention.

The examples which follow illustrate the advantages of the present invention.

### EXAMPLES

### Synthesis of Polymers

### Polymer 1

A glass reactor vessel equipped with multiple necks, a mechanical stirrer, pH-meter and dosing equipment (e.g. syringe pump) was charged with 267 g of water and 330.9 g of molten vinyl-PEG 3000 (solution A). The temperature in the reactor was adjusted to 13° C. and the pH was adjusted to approximately 7 by addition of 3 g of 25% sulfuric acid solution. A portion (20.5 g) of a previously prepared second solution (solution B), consisting of 152.11 g water and 52.82 g of hydroxy ethyl acrylate (HEA, 98.5%) was added to the reactor vessel drop wise over a period of 10 minutes under moderate stirring. A pH of 6.8 was measured for the resulting solution in the reactor. To the remaining solution B was added 2.9 g 3-mercaptopropionic acid (3-MPA). A further amount of 0.52 g 3-MPA was added to the reactor shortly before initiation of polymerization. A third solution, (solution C) containing 1.5 g of sodium hydroxymethane sulfinate dihydrate in 48.5 g water was prepared. The polymerization was initiated by adding 21 mg FeSO₄×7H₂O that was dissolved in several milliliters of water and 1.34 g of H₂O₂ (30%) solution to the reaction vessel. Simultaneously, the dosing of solution B and C into the polymerization vessel was started. Solution B was dosed over a period of 30 minutes using varying addition rates as described in the table below. Solution C was dosed at a constant speed of 1.54 g/h over a period of 30 minutes followed by a higher dosing speed of 50 g/h over an additional 10 minutes. During the 30 minute dosing period of solution B, the pH in the reactor was maintained at 6.8 by adding 20% aqueous NaOH solution. The pH of the polymer solution after the addition of solution C was 7.1 and 0.2 g of 25% sulfuric acid was added to adjust the pH to 7. An aqueous solution of a polyether-polyester copolymer with a yield of 91%, a weight-average molecular weight of 37 kDa (GPC; against PEO/PEG-Standard) and a solids content of 46.8% was obtained. The polymer solution was concentrated to 48.4% by rotary evaporator.

### Polymer 2

In a double-walled reaction vessel (1000 mL four-necked flask) equipped with reflux condenser, stirrer, thermometer, pH meter, and dropping funnel, was charged with 200 g of polymer solution 1. Thereto, 96.8 g of a 50% sodium hydroxide solution were added dropwise while stirring. After 30 min of stirring, a pH of 13.5 resulted. The reaction solution was allowed to stir at room temperature for 24 h. After neutralization of the reaction mixture with a corresponding amount of a sulfuric acid solution (25%), a pH of 7.2 resulted. Purification was performed using dialysis (cellulose ester membrane tubing; MWCO 500-1000 Da) for 24 h in 30 L water (with water change). The polymer solution was concentrated using a rotary evaporator. The resulting product was a polymer solution having a solids content of 31.8% by weight and a molecular weight of Mw 37 kDa (GPC; against PEO/PEG-Standard)

### Polymer 3

In a double-walled reaction vessel (1000 mL four-necked flask) equipped with reflux condenser, stirrer, thermometer, pH meter, and dropping funnel, was charged with 200 g of polymer solution 1 and 28.06 g hydroxylamine hydrochloride (99.9%) in 50 g water were added dropwise while stirring. A pH of 4.8 resulted and the solution was stirred for 30 min at room temperature. Thereto, 96.8 g of a 5-10° C. cold sodium hydroxide solution (50%) was added dropwise within 20 min while stirring. The reaction mixture reached a temperature of ˜30° C. and a pH of 13.1. After stirring for one hour, 8.0 g of a 5-10° C. cold sodium hydroxide solution (50%) was added dropwise. After stirring overnight, the pH was adjusted to pH of 13 by using the corresponding amount of sodium hydroxide solution (50%) which was added dropwise while stirring. After stirring for one hour, the reaction mixture was neutralized by adding a sulfuric acid solution (25%) until a pH of 7.1 resulted. Purification was performed using dialysis (cellulose ester membrane tubing; MWCO 500-1000 Da) for 24 h in 10 L water (with water change). The polymer solution was concentrated using a rotary evaporator. The resulting product was a polymer solution having a solids content of 37.0%. The proportions of carbon, hydrogen and nitrogen in the polymer were determined by elemental analysis (vario EL CUBE from Elementar at a combustion temperature of 950° C.) and compared with the theoretical values. Thereafter, the esters of polymer 1 were converted to 33% to the hydroxamic acid and to 67% to the carboxylic acid.

### Polymer 4

A glass reactor vessel equipped with multiple necks, a mechanical stirrer, pH-meter and dosing equipment (e.g. syringe pump) was charged with 138 g water and 182 g of molten vinyl-PEG 1100 (solution A). The temperature in the reactor was adjusted to 12° C. and the pH was adjusted to approximately 7 by addition of 4 g of 25% sulfuric acid solution. A portion (59.63 g) of a previously prepared second solution, (solution B), consisting of 228.17 g water and 79.22 g of hydroxyethyl acrylate (HEA, 98.5%) was added to the reactor vessel drop wise over a period of 10 minutes while stirring moderately. A pH of 6.5 was measured for the resulting solution in the reactor. To the remaining solution B was added 2.28 g 3-mercaptopropionic acid (3-MPA). A further amount of 0.76 g 3-MPA was added to the reactor shortly before initiation of polymerization. A third solution, (solution C) containing 1.5 g of sodium hydroxymethane sulfinate dihydrate in 48.5 g water was prepared. The polymerization was initiated by adding 31 mg FeSO₄×7H₂O in several milliliters of water and 2.01 g of H₂O₂ (30%) solution to the reaction vessel. Simultaneously, the dosing of solution B and C was started into the polymerization vessel. Solution B was dosed over a period of 30 minutes. Solution C was dosed at a constant speed of 4.5 g/h over a period of 30 min followed by a higher dosing speed of 75 g/h over an additional 6 minutes. During the 30 minute dosing period of solution B, the pH in the reactor was maintained at 6.5 by adding 20% aqueous NaOH solution. The pH of the polymer solution after the addition of solution C was 7.1 and 0.24 g of 25% sulfuric acid solution was added to adjust the pH to 7. An aqueous solution of a polyether-polyester copolymer with a yield of 97.7%, a weight-average molecular weight of M_{W}˜37 kDa (GPC; against PEO/PEG-Standard) and a solids content of 38.9% was obtained. The polymer solution was concentrated to 42.8% by rotary evaporator.

### Polymer 5

In a procedure similar to the synthesis of polymer 3, an aliquot of the polymer 4 solution (40.0 g) was mixed with 4.9 g of a 48% sodium hydroxide solution overnight. After neutralization and purification via dialysis (like described for polymer 2), The resulting polymer solution has a solids content of 18.0% and a molecular weight of M_{W}˜37 kDa (GPC; against PEO/PEG-Standard).

### Polymer 6

In a procedure similar to the synthesis of polymer 3, an aliquot of the polymer 4 solution (70.1 g) was mixed with 10.64 g hydroxylamine hydrochloride (98%) in 40 g water. During the reaction overnight, the pH was kept constant at ˜13 by the addition of a sodium hydroxide solution (18%). After neutralization and purification via dialysis (like described for polymer 3), the resulting polymer solution has a solids content of 8% and a molecular weight of M_{W}˜37 kDa (GPC; against PEO/PEG-Standard). The proportions of carbon, hydrogen and nitrogen in the polymer were determined by elemental analysis (vario EL CUBE from Elementar at a combustion temperature of 950° C.) and compared with the theoretical values. Thereafter, the esters of polymer 4 were converted to 52% to the hydroxamic acid and to 48% to the carboxylic acid.

### Polymer 7

Synthesis of ring-opened maleic anhydride with hydroxamic acid=MSA-hydroxamic acid:

In a reaction vessel (250 mL four-necked flask) equipped with reflux condenser, stirrer, thermometer, pH meter, dropping funnel, and Almemo data logger, a solution of 10.21 g hydroxylammonium chloride (98%) in 50 mL water was stirred. At 25° C. while stirring, a 20% sodium hydroxide solution was added dropwise until a pH of 7-8 was reached. Afterwards, 14.26 g maleic anhydride (99%) were added within 1 hour while stirring and keeping the reaction temperature at 25°° C. by cooling. During this time, the pH was kept constant between 7-8 by post-dosing of the sodium hydroxide solution. After stirring for 30 min, the reaction mixture was evaporated to dryness. The yellowish residue was mixed with toluene and evaporated to dryness. A brownish solid material was obtained with a purity of 70% which was determined by 1H-NMR. The by-products result from a competitive reaction (Michael addition).

In a reaction vessel (100 mL three-necked flask) equipped with reflux condenser, stirrer, thermometer, pH meter, dropping funnel, Almemo data logger and two feed facilities was charged with 20 g water. Thereto, 17.6 g of melted VOBPEG 1100 were added while stirring.

Subsequently, in a separate feed vessel, 0.24 g Rongalit C were mixed with 11.76 g water (solution 1). In parallel, a solution of 4.56 g MSA-hydroxamic acid and 10.65 g water was prepared (solution 2).

After raising the temperature of 25° C., 7.6 g of solution 2, 0.04 g 3-mercaptopropionic acid and 0.015 g Fe₂(SO₄)₃*7H₂O₂ were added to the VOBPEG-solution. Afterwards, 0.07 g 3-mercaptopropionic acid were added to the remaining solution 2.

After adjusting a pH of 5.0 by addition of corresponding amounts of 10% sulfuric acid solution, 0.5 g of a 50% strength aqueous H₂O₂ solution were added. Afterwards, the addition of solutions 1 and 2 was commenced, while the pH was kept constant between 4.8-5.2. Solution 1 was added with a metering rate of 2.9 mL/h, solution 2 was added at a rate of 27 mL/h. After the solution 2 was completely added, the addition of solution 1 was continued until the solution was peroxide-free. The polymer solution obtained was adjusted to a pH of 6.5 with 20% strength aqueous sodium hydroxide solution. The resulting polymer solution has a solids content of 33.0% and a molecular weight of M_{W}˜5 kDa (GPC; against PEO/PEG-Standard).

### Polymer 8

In a 1000 mL double-walled reaction vessel equipped with reflux condenser, stirrer, thermometer, pH meter, dropping funnel, Almemo data logger and several feed facilities was charged with 464 g water. Thereto, 377 g of melted VOBPEG 3000 were added while stirring. After the solution was tempered to 15° C., 0.04 g Fe₂(SO₄)₃*7H₂O, 3.3 g Rongalit C, 4.5 g 3-mercaptopropionic acid and 133.4 g 2-hydroxyethyl acrylate (98% ig) were added. The cooling was removed and, thereto, 1.3 g of a 50% strength aqueous H₂O₂ solution were added. After the addition, the reaction mixture reached a temperature of 30° C. within two minutes and stirring was continued for 30 min. The resulting product was a polymer solution having a solids content of 51.6% by weight and a molecular weight of M_{W}˜28 kDa (GPC; against PEO/PEG-Standard).

### Polymer 9

In a procedure similar to the synthesis of polymer 2, an aliquot of the polymer 8 solution (550 g) was mixed with 72.7 g of a 31% sodium hydroxide solution overnight. After neutralization and purification via dialysis (like described for polymer 2), the resulting polymer solution has a solids content of 31.8% and a molecular weight of M_{W}˜28.0 kDa (GPC; against PEO/PEG-Standard).

### Polymer 10

In a procedure similar to the synthesis of polymer 3, an aliquot of the polymer 8 solution (530.0 g) was mixed with 12.7 g hydroxylamine hydrochloride (99.9%) in 50 g water. During the reaction overnight, the pH was kept constant at ˜13 by the addition of a sodium hydroxide solution (50%). After neutralization with sulfuric acid (25%) and purification via dialysis (like described for polymer 3), the resulting polymer solution has a solids content of 37.0% and a molecular weight of M_{W}˜28.2 kDa (GPC; against

PEO/PEG-Standard). The proportions of carbon, hydrogen and nitrogen in the polymer were determined by elemental analysis (vario EL CUBE from Elementar at a combustion temperature of 950° C.) and compared with the theoretical values. Thereafter, the esters of polymer 8 were converted to 30.5% to the hydroxamic acid and to 69.5% to the carboxylic acid.

Fluidizing power and clay robustness of the inventive compositions were demonstrated with two binder preparations:

Stucco A, pure clay-free ß-hemihydrate from FGD, and clay-containing stucco B.

Stucco B was obtained by loading clay-free FGD stucco with clay by substitution of 0.07 mass-% stucco with 0.70% Bentonite Na-form.

Plast Retard L is the commercial product by Sicit 2000. Bentonite Na-form (10232802) is the used clay mineral.

Slump test

Flow was determined after a time of 60 seconds. After adding powder components to liquid, the stucco had to soak for 15 seconds. Then the slurry was mixed for 30 seconds with a Hobart mixer. After a total time of 45 seconds an ASTM ring was filled with the stucco slurry up to the top edge and lifted after 60 seconds. At the end the patty diameter was measured with a calliper rule on two perpendicular axes.

### Hardening Time

Initial setting was determined with the so-called knife-cut method (analogous to DIN EN 13279-2).

### Preparation of the Slurries

### Reference Example Ref1

As a reference, a blank gypsum slurry not containing any dispersant was produced using 300 g of Stucco A and 0.10 g accelerator (fine milled dihydrate from ball mill) to adjust a setting time of 4:10 min: s. The quantity of water needed corresponding to a water-to-binder (w/b) ratio of 0.660 and determined on the basis of the untreated gypsum slurry is charged into a mixing vessel (mixer according to DIN EN 196-1) and then Stucco A and accelerator are sprinkled carefully into the water. Further, Plast Retard L in amounts as indicated in Table 1 is added to the mixing water. The slurry was stirred for 30 seconds at 285 rpm. Water-to-binder (w/b) ratio of 0.660 was adjusted to achieve a flow of 20.6 cm for reference example.

### Further Examples of Table 1

A slurry was produced using 300 g of Stucco A and 0.10 g accelerator. The quantity of water needed corresponding to a water-to-binder (w/g) ratio of 0.660 and determined on the basis of the untreated gypsum slurry is charged into a mixing vessel (mixer according to DIN EN 196-1) and then the Stucco A and accelerator were sprinkled carefully into the water. Plast Retard L and the polymer as depicted in Table 1 were added to the mixing water in amounts as indicated in Table 1. The slurry was stirred for 30 seconds at 285 rpm.

TABLE 1
Composition and properties of the application examples with Stucco A containing
the comparative and inventive construction chemical compositions

| Example | Ref1 | CE1.1 | CE1.2 | CE1.3 | IE1.1 | IE1.2 | IE1.3 |
|---|---|---|---|---|---|---|---|
| Stucco A | 300 | 300 | 300 | 300 | 300 | 300 | 300 |
| (Binder) [g] | | | | | | | |
| H₂O/Stucco A | 0.660 | 0.660 | 0.660 | 0.660 | 0.660 | 0.660 | 0.660 |
| Dry Powder Ball | 0.10 | 0.10 | 0.10 | 0.10 | 0.10 | 0.10 | 0.10 |
| Mill Accelerator | | | | | | | |
| [% bws] | | | | | | | |
| Dispersant | | 1 | 2 | 4 | 3 | 6 | 7 |
| (Polymer Nr.) | | | | | | | |
| Dispersant | 0.00 | 0.10 | 0.10 | 0.10 | 0.10 | 0.10 | 0.10 |
| (active matter) | | | | | | | |
| [% bws] | | | | | | | |
| Plast Retard L | 2.4 | 2.4 | 2.4 | 2.4 | 2.4 | 2.4 | 2.4 |
| (1% active) [g] | | | | | | | |
| Flow [cm] | 20.6 | 21.0 | 26.2 | 21.2 | 30.1 | 30.1 | 29.8 |
| Stiffening time | 4:10 | 5:10 | 9:55 | 5:05 | 7:35 | 7:45 | 7:50 |
| [min:s] | | | | | | | |

[% bws] = Percent by weight of stucco

According to Table 1, the flow behaviour of gypsum slurry prepared with reference dispersants (CE1.1 and CE1.3) with hydroxy anchor groups is only slightly improved compared to the blank reference (Ref1) containing no dispersant. Dispersant with only carboxy anchor groups (CE1.2) shows good fluidizing power, however, the retardation is the highest which is disadvantageous.

Dispersants of inventive examples (IE1.1, IE1.2 and IE 1.3) improved flow significantly in comparison to reference (Ref1) but also in comparison to the polymer 2 with carboxy anchor groups (CE1.2). Results indicate fluidizing power of inventive hydroxamic acid bearing comb polymers in pure FGD stucco with moderate retardation power.

### Reference Example Ref2

As a reference, a blank gypsum slurry not containing any dispersant was produced using 300 g of Stucco B and 0.10 g accelerator (fine milled dihydrate from ball mill) to adjust a setting time of 4:20 min: s. The quantity of water needed corresponding to a water-to-binder (w/b) ratio of 0.660 and determined on the basis of the untreated gypsum slurry is charged into a mixing vessel (mixer according to DIN EN 196-1) and then

Stucco B and accelerator are sprinkled carefully into the water. Further, Plast Retard L in amounts as indicated in Table 1 is added to the mixing water. The slurry was stirred for 30 seconds at 285 rpm. Water-to-binder (w/b) ratio of 0.660 was adjusted to achieve a flow of 19.0 cm for reference example.

### Further Examples of Table 2

A slurry was produced using 300 g of Stucco B and 0.10 g accelerator. The quantity of water needed corresponding to a water-to-binder (w/g) ratio of 0.660 and determined on the basis of the untreated gypsum slurry is charged into a mixing vessel (mixer according to DIN EN 196-1) and then the Stucco A and accelerator were sprinkled carefully into the water. Plast Retard L and the polymer as depicted in Table 2 were added to the mixing water in amounts as indicated in Table 2. The slurry was stirred for 30 seconds at 285 rpm.

TABLE 2
Composition and properties of the application examples
with Stucco B containing the comparative and inventive
construction chemical compositions

| | Ref2 | CE2.1 | CE2.2 | CE2.3 | IE2.1 | IE2.2 |
|---|---|---|---|---|---|---|
| Stucco B | 300 | 300 | 300 | 300 | 300 | 300 |
| (Binder) [g] | | | | | | |
| H₂O/Stucco B | 0.660 | 0.660 | 0.660 | 0.660 | 0.660 | 0.660 |
| Dry Powder | 0.10 | 0.10 | 0.10 | 0.10 | 0.10 | 0.10 |
| Ball Mill | | | | | | |
| Accelerator | | | | | | |
| [% bws] | | | | | | |
| Dispersant | | 1 | 2 | 4 | 3 | 6 |
| (Polymer Nr.) | | | | | | |
| Dispersant | 0.00 | 0.10 | 0.10 | 0.10 | 0.10 | 0.10 |
| (active matter) | | | | | | |
| [% bws] | | | | | | |
| Plast Retard L | 2.4 | 2.4 | 2.4 | 2.4 | 2.4 | 2.4 |
| (1% active) [g] | | | | | | |
| Flow [cm] | 19.0 | 18.9 | 20.5 | 19:0 | 24.4 | 24.2 |
| Stiffening time | 4:20 | 5:00 | 6:00 | 4:55 | 5:50 | 5:55 |
| [min:s] | | | | | | |

[% bws] = Percent by weight of stucco

According to Table 2, the flow behaviour of gypsum slurry prepared with reference dispersants (CE2.1 and CE2.3) is equal compared to the blank reference (Ref2) containing no dispersant. Dispersant with only carboxy anchor group (CE2.2) shows a loss in fluidizing power in the presence of bentonite (clay) in the stucco. Dispersants of inventive examples (I.E2.1 and IE2.2) improved flow significantly in comparison to reference (Ref2) and also in comparison with “classical” only carboxy anchor groups bearing comb polymers. Results indicate fluidizing power of inventive hydroxamic acid bearing comb polymers also in clay-contaminated FGD stucco.

For an application in a cementitious system, the polymers 8, 9, and 10 were tested in the compound depicted in Table 3. The dosage of the polymer was adjusted to reach a Hägermann cone flow of 28±2 cm. Flow was determined in analogy to DIN EN 1015-3. The Hägermann cone (d at the top=70 mm, d at the bottom=100 mm, h=60 mm) was placed in the middle of a dry glass plate having a diameter of 400 mm and filled with the cement mortar. 5 min. after the first contact between cement and water the cone was lifted and the average diameter of the formed cake was determined. For the inventive hydroxamic anchor groups-bearing comb polymer (polymer 10), the polymer dosage with 0.13% bwoc was the lowest. Whereas, the comparative polymers need a higher dosage to reach the same flow, such as 0.16% bwoc for the “classic” PCE comb polymer (polymer 9) with only carboxy anchor groups (polymer 9) and 0.17% bwoc for the comb polymer (polymer 8) with hydroxy anchor groups.

TABLE 3
Building material composition

| Constituents (quality) | Function | Amount |
|---|---|---|
| Milke (CEM I 52, 5N) | OPC-binder | 40 parts |
| Quartz sand (standard) | Filler | 60 parts |
| Polymer 8, 9, or 10 | Superplasticizer (additive) | Dosed on 28 ± 2 cm |
| DF 9010 | Defoamer (additive) | 0.05% bwoc |
| Water | Starting hydration | w/c** = 0.35 |

*bwoc = by weight of cement
**w/c = water-to-cement ratio

The beginning (AB) and the end (AE) of solidification was determined on the cement paste in an analogy to DIN EN 196-3 using a Vicat needle instrument with a 300 g needle.
Polymer 8: AB: 236 min; AE: 323 min
Polymer 9: AB: 263 min; AE: 367 min
Polymer 10: AB: 245 min; AE: 300 min

1-15. (canceled)

16. Water-soluble polymer comprising:
a) a main chain which consists of a carbon chain with at least 16 carbon atoms; and
b) polyether side chains, wherein hydroxamic acid groups or salts thereof are attached to the main chain.

17. Water-soluble polymer according to claim 16, wherein the polyether side chains of the water-soluble polymer are polyether groups of the structural unit (I), 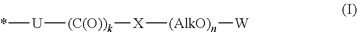
where
* indicates the bonding site to the acid group-containing polymer,
U is a chemical bond or an alkylene group having 1 to 8 C atoms,
X is oxygen, sulfur or a group NR¹,
k is 0 or 1,
n is an integer whose average value, based on the acid group-containing polymer, is in the range from 3 to 300,
Alk is C₂-C₄ alkylene, and within group (AIk-O)ₙ Alk may be identical or different,
W is a hydrogen, a C₁-C₆ alkyl, or an aryl radical or is the group Y-F, where
Y is a linear or branched alkylene group having 2 to 8 C atoms and may carry a phenyl ring,
F is a 5 -to 10-membered nitrogen containing heterocycle which is bound via nitrogen and which as ring members, besides the nitrogen atom and beside carbon atoms, may have 1, 2 or 3 additional heteroatoms selected from oxygen, nitrogen, and sulfur, it being possible for the nitrogen ring members to have a group R², and for 1 or 2 carbon ring members to be present in the form of a carbonyl group,
R¹ is hydrogen, C₁-C₄ alkyl or benzyl, and
R² is hydrogen, C₁-C₄ alkyl or benzyl.

18. Water-soluble polymer according to claim 16, wherein the water-soluble polymer is a copolymer comprising structural units (Va) 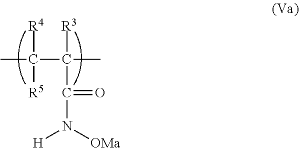
wherein
R³ and R⁴ independently from each other are hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms
R⁵ is H, —COOMₐ, —CO—NH—(OMₐ), —CO—- (C_{q}H_{2q}O)ᵣ—R³, —CO—NH—(C_{q}H_{2q}O)ᵣ—R³
M is hydrogen, a mono-, di- or trivalent metal cation, ammonium ion, or an organic amine radical
a is ⅓, ½ or 1
q independently at each occurrence and in a manner identical or different for each (C_{q}H_{2q}O) unit is 2, 3 or 4 and
r is 0 to 200.

19. Water-soluble polymer according to claim 16, wherein the water-soluble polymer is a copolymer comprising structural units (Vb) 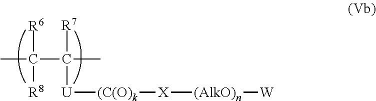
R⁶, R⁷ and R⁸ independently from each other are hydrogen, an aliphatic hydrocarbon radical having 1 to 20 C atoms, a cycloaliphatic hydrocarbon radical having 5 to 8 C atoms, or an optionally substituted aryl radical having 6 to 14 C atoms, and
U, k, X, Alk, n and W possess definitions stated in structural unit (I).

20. The water-soluble polymer according to claim 16, wherein the polymer is a polycondensation product comprising
(II) a structural unit containing an aromatic or heteroaromatic and the polyether group,
(III) a structural unit containing a hydroxamic acid group or their salts and an aromatic or heteroaromatic moiety.

21. The water-soluble polymer according to claim 20, wherein the structural units (II) and (III) are represented by the following general formulae 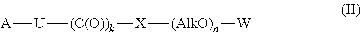
where
A is identical or different and is represented by a substituted or unsubstituted, aromatic or heteroaromatic compound having 5 to 10 C atoms in the aromatic system,
U, k, X, Alk, n and W possess definitions stated in structural unit (I), 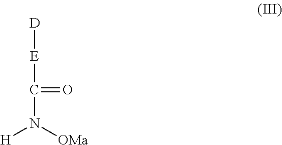
where
D is identical or different and is represented by a substituted or unsubstituted, aromatic or heteroaromatic compound having 5 to 10 C atoms in the aromatic system,
where
E is a chemical bond
or —(C(O))ₖ—X—(AlkO)ₙ—Z—,
wherein
X is oxygen or a group NR⁹,
k is 0 or 1,
n is an integer whose average value, based on the acid group-containing polymer, is in the range from 0 to 100,
Alk is C₂-C₄ alkylene, and within group (Alk-O)ₙ Alk may be identical or different,
R⁹ is hydrogen, C₁-C₄ alkyl or benzyl
Z is C₁-C₃ alkylene.

22. The water-soluble polymer according to claim 20, wherein the polycondensation product comprises a further structural unit (IV) which is represented by the following formula: 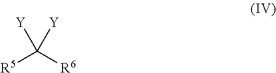
wherein each Y is independently the structural unit (II), the structural unit (III) or a further constituent of the polycondensation product, and
each R⁵ and each R⁶ is independently H, CH₃, COOH, or a substituted or unsubstituted, aromatic or heteroaromatic compound having 5 to 10 carbon atoms.

23. Water-soluble polymer according to claim 16, wherein the polymer has an average ratio of the number of moles of hydroxamic acid groups or their salts to the total molar mass of the polymer of from 1/200 to 1/2000 mol/(g/mol), wherein cations, including protons, associated with the comb polymer are not taken into account in calculating the total molar mass of the polymer.

24. Water-soluble polymer according to claim 18, wherein the copolymer has an average molar weight (Mw) of between 2 000 and 200 000 g/mol, as determined by gel permeation chromatography.

25. Water-soluble polymer according to claim 20, wherein the polycondensation product has an average molar weight (Mw) of between 3 000 and 150 000 g/mol, as determined by gel permeation chromatography.

26. Water-soluble polymer according to claim 16, which is present as a powder.

27. Inorganic particle composition comprising a water-soluble polymer according to claim 16.

28. Inorganic particle composition according to claim 27, wherein the composition comprises inorganic binders or inorganic pigments.

29. Inorganic particle composition according to claim 27, wherein the composition comprises 0.005 to 3 weight-% of the water-soluble polymer based on the total dry weight of the inorganic particles.

30. Use of a water-soluble polymer according to claim 16 as dispersant in inorganic particle compositions.
